(19) United States
(12) Patent Application Publication
(10) Pub. No.: US 2015/0229598 A1
(43) Pub. Date: Aug. 13, 2015

(54) METHOD AND SYSTEM OF SYNCHRONING AN UNREAD MESSAGE IN INSTANT COMMUNICATION

(71) Applicant: Alibaba Group Holding Limited, Grand Cayman (KY)

(72) Inventors: Meng Peng, Hangzhou (CN); Shihan Wang, Hangzhou (CN)

(21) Appl. No.: 14/617,700

(22) Filed: Feb. 9, 2015

(30) Foreign Application Priority Data
Feb. 11, 2014 (CN) 201410048460.1

(51) Int. Cl. H04L 12/58

(52) U.S. Cl. CPC H04L 51/22; H04L 51/04

(57) ABSTRACT

A method and a system of synchronizing an unread message of instant communication are disclosed. The method includes: obtaining information of an unread message in each dialogue associated with an instant messaging account from a server when the account is logged in via a current terminal; and displaying the information of the unread message in the current terminal, wherein the unread message is a message with time information that is larger than a first time stamp in each dialogue, the first time stamp being time information of a most recently read message in each dialogue submitted by the instant messaging account, and the first time stamp corresponding to each dialogue of the instant messaging account being stored in the server. The embodiments of the present disclosure avoid the problem of repeatedly sending unread messages among different terminals and the problem of failing to synchronize statistical information of the unread messages, thus reducing the system resource occupancy in a server and a terminal, achieving a seamless synchronization of information associated with the unread messages among the different terminals, and improving the experience of a user.

### CROSS REFERENCE TO RELATED PATENT APPLICATION

This application claims foreign priority to Chinese Patent Application No. 201410048460.1 filed on Feb. 11, 2014, entitled “Method and System of Synchronizing an Unread Message in Instant Communication”, which is hereby incorporated by reference in its entirety.

### TECHNICAL FIELD

The present disclosure relates to the technical field of communication technology, and more particularly to methods and systems of synchronizing an unread message in instant communication.

### BACKGROUND

With the continuous development of the Internet and communication technology, and an ever-increase in Internet users, the Internet and communication fields have gained unprecedented success, and the number of Internet users has reached several billions.

A communication system based on the Internet and communication technology has been accepted by an increasing number of people and has become popularly used at work, for studying and in the daily lives of people. It can be said that the communication system has become an indispensible part of the daily lives of people. Especially due to the popularity of mobile devices in recent years (such as smartphones or tablets like iPads), the demand of using these types of portable mobile devices for work is getting stronger in various commercial/industrial fields, especially in instant messaging.

However, in existing technologies, messages cannot be seamlessly synchronized between mobile terminals currently, causing the statuses of the messages being different in various terminals and thus seriously affecting user experience. Using instant communication as an example. The instant communication may support conversation among two or more person, in which an unread message (i.e., a chatting message that has not been read by a present user) is generated if the present user is off-line but other users continue to chat, or if the present user is busy with other things and fails to read messages. After the present user logs in at a terminal A and reads the unread messages (such as messages left by his/her buddies), statuses of the unread messages change to “read”. However, when the present user logs in again at another terminal B, he/she may find that the messages that have been read (such as the above message left by the buddies) at the terminal A are still in an unread status on the terminal B. Sending the unread messages repeatedly not only increases occupancy of resources of a server and a terminal, but also causes the user to repeatedly read the same messages, which significantly affects the experience of user.

Therefore, a technical problem needs to be solved by one skilled in the art is to provide a synchronization mechanism for unread messages, used for synchronizing the unread messages among different terminals, thus reducing occupancy of resources of a server and a terminal and thereby enhancing the user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method of synchronizing an unread message of an instant communication, used for synchronizing the unread message among different terminals, and thus reducing the occupancy of resources in a server and a terminal and enhancing the experience of a user.

Correspondingly, the present disclosure provides a system of synchronizing an unread message of an instant communication, used for ensuring implementation and application of the above method.

In order to solve the aforementioned problems, the present disclosure provides a method of synchronizing an unread message of an instant communication, which comprises:

obtaining information of an unread message in each dialogue associated with an instant messaging account from a server when the account is logged in via a current terminal; and

displaying the information of the unread message in the current terminal,

wherein the unread message is a message with time information that is larger than a first time stamp in each dialogue, the first time stamp being time information of a most recently read message in each dialogue submitted by the instant messaging account, and the first time stamp corresponding to each dialogue of the instant messaging account being stored in the server.

In an embodiment, the information of the unread message comprises: the first time stamp in each dialogue, a number of unread messages in each dialogue, and/or last message in each dialogue.

In an embodiment, other terminals correspond to terminals, other than the current terminal, via which the same instant messaging account is logged in or has been logged in.

In an embodiment, the method further comprises: applying the first time stamp in the information of the unread message to update a second time stamp in each dialogue on the current terminal.

In an embodiment, the method further comprises:

determining whether a message received in an ongoing dialogue has been read when an exchange of messages is performed in the dialogue on the current terminal based on the instant messaging account;

if affirmative, sending the time information of the read message to the server, the server being used for updating the first time stamp corresponding to the dialogue using the time information, determining that a message in the dialogue having respective time information larger than the first time stamp is an unread message.

In an embodiment, determining whether the message received in the ongoing dialogue has been read further comprises:

determining whether a window corresponding to the ongoing dialogue is at focus;

if affirmative, determining that the message received in the ongoing dialogue is a read message; and/or

determining whether the window corresponding to the ongoing dialogue exceeds a default area of coverage; and

if not, determining that the message received in the ongoing dialogue is a read message.

In an embodiment, the method further comprises: updating the second time stamp corresponding to the dialogue that is stored in the server using time information of the read message.

In an embodiment, the method further comprises:

receiving the first time stamp corresponding to the dialogue of the instant messaging account from the server, the first time stamp being time information of a most recent read message in the dialogue sent from another terminal.

In an embodiment, the method further comprises:

applying the first time stamp corresponding to the dialogue to update the second time stamp in the dialogue stored in the server.

In an embodiment, the method further comprises:

downloading roaming messages corresponding to one or more dialogues from the server when entering a window corresponding to the one or more dialogues, the roaming messages including a message sent from instant messaging account and a message received by the instant messaging account;

setting the sent message as a read message and displaying the read message;

and/or,

setting a received message with respective time information larger than the second time stamp as an unread message, and displaying the unread message;

and/or,

setting a received message with respective time information smaller than or equal to the second time stamp as a read message, and displaying the read message.

The present disclosure further provides a method of synchronizing an unread message of an instant communication, which includes:

retrieving information of an unread message in each dialogue corresponding to an instant messaging account when the instant messaging account is logged in at a current terminal;

transmitting the information of the unread message in each dialogue corresponds to the instant messaging account to the current terminal, wherein the unread message in each dialogue is a message with time information being larger than a first time stamp, the first time stamp is time information of a most recent read message in each dialogue submitted by the instant messaging account, and the first time stamp corresponding to each dialogue of the instant messaging account is stored in a server.

In an embodiment, the information of the unread message comprises: the first time stamp in each dialogue, a number of unread messages in each dialogue, and/or a last message in each dialogue.

In an embodiment, other terminals correspond to terminals, other than the current terminal, in which the same instant messaging account is logged in or has been logged in.

In an embodiment, the method further comprises:

receiving the time information of the read message submitted from the current terminal, wherein the time information of the read message is time information of a message that is received by an ongoing dialogue and is determined by the current terminal to have been read when an exchange of messages is conducted in the ongoing dialogue based on the instant messaging account;

updating the first time stamp corresponding to the dialogue using the time information; and

setting a message with time information larger than the first time stamp as an unread message.

In an embodiment, the method further comprises:

applying the first time stamp to perform statistics on information of unread messages in the dialogue.

In an embodiment, the method further comprises:

receiving time information of read messages currently received in the dialogue from the current terminal when the instant messaging account is logged in at a plurality of terminals and an exchange of messages is conducted in the dialogue by the current terminal; and

applying the time information to update the first time stamp corresponding to the dialogue; and

transmitting the first time stamp corresponding to the dialogue to other terminals.

The present disclosure further provides a system of synchronizing an unread message of an instant communication, which includes:

an unread message acquisition module used for obtaining information of an unread message in each dialogue associated with an instant messaging account from a server when the account is logged in via a current terminal; and

an unread message display module used for displaying the information of the unread message in the current terminal,

wherein the unread message is a message with time information that is larger than a first time stamp in each dialogue, the first time stamp being time information of a most recently read message in each dialogue submitted by the instant messaging account, and the first time stamp corresponding to each dialogue of the instant messaging account being stored in the server.

In an embodiment, the information of the unread message comprises: the first time stamp in each dialogue, a number of unread messages in each dialogue, and/or last message in each dialogue.

In an embodiment, other terminals correspond to terminals, other than the current terminal, via which the same instant messaging account is logged in or has been logged in.

In an embodiment, the system further comprises:

a first updating module used for applying the first time stamp in the information of the unread message to update a second time stamp in each dialogue on the current terminal.

In an embodiment, the system further comprises:

a read determination module used for determining whether a message received in an ongoing dialogue has been read when an exchange of messages is performed in the dialogue on the current terminal based on the instant messaging account, and if affirmative, calling a time information sending module;

the time information sending module used for sending the time information of the read message to the server, the server being used for updating the first time stamp corresponding to the dialogue using the time information, determining that a message in the dialogue having respective time information larger than the first time stamp is an unread message.

In an embodiment, the read determination module further comprises:

a focus determination sub-module used for determining whether a window corresponding to the ongoing dialogue is at focus, and if affirmative, invoking a read determination sub-module;

and/or

a coverage determination sub-module used for determining whether the window corresponding to the ongoing dialogue exceeds a default area of coverage, and if not, invoking the read determination sub-module; and

the read determination sub-module used for determining that the message currently received in the dialogue has been read.

In an embodiment, the system further comprises:

a second updating module used for updating the second time stamp corresponding to the dialogue that is stored in the server using time information of the read message.

In an embodiment, the system further comprises:

a first time stamp receiving module used for receiving the first time stamp corresponding to the dialogue of the instant messaging account from the server, the first time stamp being time information of a most recent read message in the dialogue sent from another terminal.

In an embodiment, the system further comprises:

a third updating module used for applying the first time stamp corresponding to the dialogue to update the second time stamp in the dialogue stored in the current terminal.

In an embodiment, the system further comprises:

a roaming message downloading module used for downloading roaming messages corresponding to one or more dialogues from the server when entering a window corresponding to the one or more dialogues, the roaming messages including a message sent from instant messaging account and a message received by the instant messaging account;

a first read message processing sub-module used for setting the sent message as a read message and displaying the read message;

and/or

an unread message processing sub-module used for setting a received message with respective time information larger than the second time stamp as an unread message, and displaying the unread message;

and/or

a second read message processing sub-module used for setting a received message with respective time information smaller than or equal to the second time stamp as a read message, and displaying the read message.

The present disclosure further provides a system of synchronizing an unread message of an instant messaging account, which includes:

an unread message retrieving module used for retrieving information of an unread message in each dialogue corresponding to an instant messaging account when the instant messaging account is logged in at a current terminal;

an unread message sending module used for transmitting the information of the unread message in each dialogue corresponds to the instant messaging account to the current terminal, wherein the unread message in each dialogue is a message with time information being larger than a first time stamp, the first time stamp is time information of a most recent read message in each dialogue submitted by the instant messaging account, and the first time stamp corresponding to each dialogue of the instant messaging account is stored in a server.

In an embodiment, information of the unread message comprises: the first time stamp in each dialogue, a number of unread messages in each dialogue, and/or a last message in each dialogue.

In an embodiment, other terminals correspond to terminals, other than the current terminal, via which the same instant messaging account is logged in or has been logged in.

In an embodiment, the system further comprises:

a first time information receiving module used for receiving the time information of the read message submitted from the current terminal, wherein the time information of the read message is time information of a message that is received by an ongoing dialogue and is determined by the current terminal to have been read when an exchange of messages is conducted in the ongoing dialogue based on the instant messaging account;

a fourth updating module used for updating the first time stamp corresponding to the dialogue using the time information; and

an unread message determination module used for setting a message with time information larger than the first time stamp as an unread message.

In an embodiment, the system further comprises:

an unread message statistics module used for applying the first time stamp to perform statistics on information of unread messages in the dialogue.

In an embodiment, the system further comprises:

a second time information receiving module used for receiving time information of read messages currently received in the dialogue from the current terminal when the instant messaging account is logged in at a plurality of terminals and an exchange of messages is conducted in the dialogue by the current terminal;

a fifth updating module used for applying the time information to update the first time stamp corresponding to the dialogue;

a first time stamp sending module used for transmitting the first time stamp corresponding to the dialogue to other terminals.

Compared with the existing technologies, the present disclosure includes the following advantages:

In the embodiments of the present disclosure, a server may store a first time stamp corresponding to each dialogue of an instant messaging account. The first time stamp is time information of the most recently read message that is received in each dialogue submitted by the instant messaging account. Therefore, a message in a dialogue of the instant messaging account having time information larger than the first time stamp may be determined as an unread message. When logging into the instant messaging account, a present terminal synchronizes information of unread messages. The mechanism for synchronizing the unread messages based on the first time stamp avoids a problem of repeatedly sending the unread messages to a plurality of terminals and further avoids a problem of unsynchronized statistics for information of the unread messages, thus reducing the occupancy of resources in a server and in a terminal and enhancing the experience of a user.

When determining read messages received in an ongoing dialogue, the embodiments of the present disclosure send time information thereof to a server for updating the first time stamp. Using the embodiments of the present disclosure, other terminals also update the first time stamp in the same way, such that the first time stamp in the server corresponds to time information of the most recent read message received in each dialogue submitted by the instant messaging account in the current terminal or another terminal. The server determines an unread message based on the first time stamp, thus ensuring the uniqueness and the accuracy of the unread message, achieving a seamless synchronization of the unread message among different terminals and enhancing the experience of a user.

In the embodiments of the present disclosure, the current terminal uses the first time stamp sent by the server to update the second time stamp of each dialogue when the instant messaging account is initially logged into the current terminal. Alternatively, upon determining whether a message currently received in the dialogue is an unread message, time information of the unread message is used for updating the second time stamp corresponding to the dialogue. Alternatively, the first time stamp sent from the server is used for updating the corresponding second time stamp when the same instant messaging account is logged in at a plurality of terminals. Accordingly, the second time stamp of each dialogue may be maintained as time information of the most recently read message received in each dialogue submitted by the instant messaging account at the current terminal or another terminal. The current terminal determines between an unread message and a read message using the second time stamp, and displays thereof accordingly, thus having strong practicability and flexibility, achieving seamless synchronization of unread messages among different terminals and enhancing the experience of a user.

### BRIEF DESCRIPTION OF THE DRAWINGS

FIG. 1 is a flow chart of a first example method of synchronizing an unread message of an instant communication.

FIG. 2 is a structural diagram illustrating a system of an instant communication in the present disclosure.

FIG. 3 is a flow chart of a second example method of synchronizing an unread message of an instant communication.

FIG. 4 is an exemplary view illustrating information of an unread message in accordance with the present disclosure.

FIG. 5 is a flow chart of for a third example method of synchronizing an unread message of an instant communication.

FIG. 6 is an exemplary view illustrating a covered area of a window corresponding to a dialogue in accordance with the present disclosure.

FIG. 7 is a flow chart of a fourth example method of synchronizing an unread message of an instant communication.

FIG. 8 is a flow chart of a fifth example method of synchronizing an unread message of an instant communication.

FIG. 9 is a flow chart of a sixth example method of synchronizing an unread message of an instant communication.

FIG. 10 is a flow chart of a seventh example method of synchronizing an unread message of an instant communication.

FIG. 11 is a structural diagram of a first example system of synchronizing an unread message of an instant communication.

FIG. 12 is a structural diagram of a second example system of synchronizing an unread message of an instant communication.

FIG. 13 is a structural diagram illustrating the system as described in FIGS. 11 and 12.

### DETAIL DESCRIPTION

To make the objectives, characteristics and advantages of the present disclosure clearer and easier to understand, the embodiments of the present disclosure are described herein in further detail using accompanying drawings and exemplary embodiments.

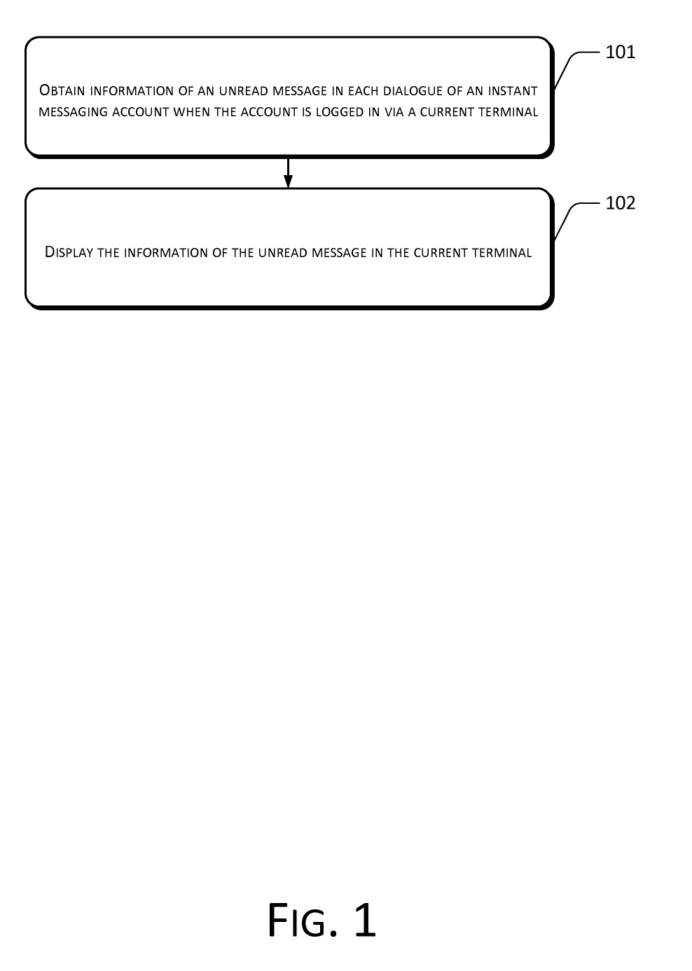

FIG. 1 illustrates a flow chart of a first example method of synchronizing an unread message of an instant communication, which may include the following:

Block 101 obtains information of an unread message in each dialogue of an instant messaging account when the account is logged in via a current terminal.

Block 102 displays the information of the unread message in the current terminal.

The unread message corresponds to a message in a dialogue with time information being larger than a first time stamp. The unread message corresponds to a message in a dialogue with time information being larger than a first time stamp means that the unread message corresponds to a message in a dialogue with time information being later than a first time stamp. The first time stamp is time information of a message that was previously read in each dialogue submitted by the instant messaging account, and the first time stamp corresponding to each dialogue of the instant messaging account is stored in the server.

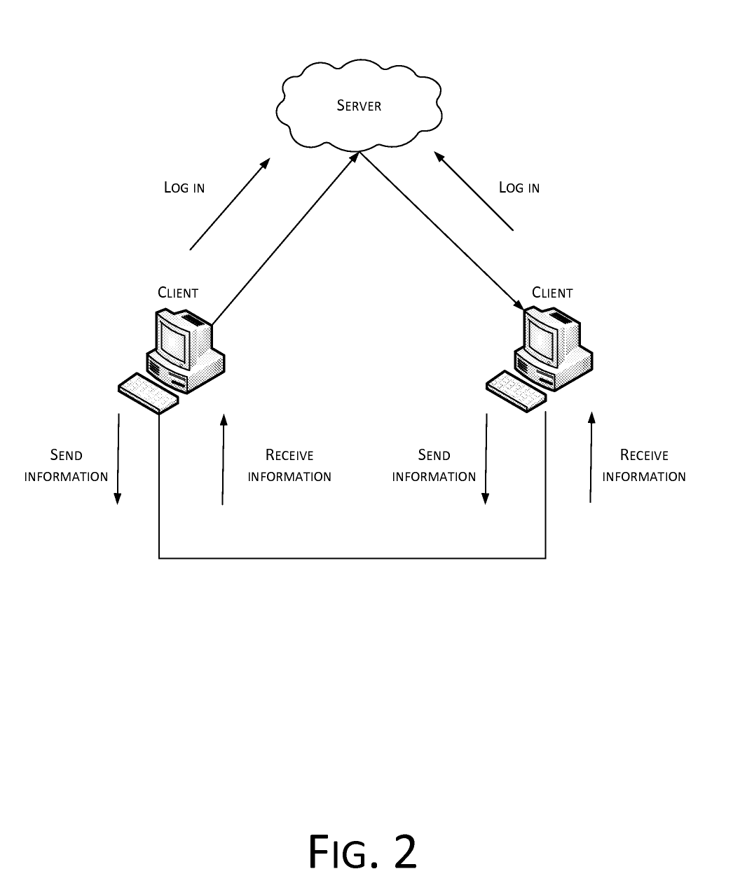

As shown in FIG. 2, the instant communication may employ a CS (i.e., Client/Server) architecture. A user first retrieves a buddy list from an IM server to establish a point-to-point communication between users. The user (client 1) and his/her friend (client 2) may send messages including texts, pictures, video or other files via the point-to-point manner. When the point-to-point communication cannot be conducted for the users, the message is relayed through an IM server.

A client may face a user who conducts instant communication. Specifically, a client may be classified as: a message sender which performs a sending operation when transmitting a message or sending a file in a point-to-point manner; and a message receiver which is opposite to the message sender and performs a receiving operation when transmitting the message or sending the file in the point-to-point manner.

In an embodiment, the instant communication may employ a P2P (i.e., Peer to Peer) architecture. Specifically, each node in a network is equivalent, acting as a client and a server, i.e., providing services to other nodes and receiving services from the other nodes at the same time. The instant communication may employ other architectures. The present disclosure does not impose any limitation thereon.

It should be noted that a client may be a client of a personal computer, a client of a webpage, and a client of a mobile device, etc. The mobile device may include a mobile apparatus such as a tablet computer, a personal digital assistant, a cellular phone, etc., according to functionalities. The mobile device may include a mobile apparatus, such as 105 (iPhone Operating System), Android, WP (Windows Phone), etc., based on operation systems. The present disclosure does not impose any limitations thereon.

In other words, the present disclosure may be applied to an application program in a computer or a mobile device. Specifically, in a real application, an application program may be developed to execute each operation in the embodiment(s) of the present disclosure when running. In an embodiment, the application program may be an independent application program or a functional module of another application program. For example, an instant messaging tool may be added with functions of an embodiment of the present disclosure, such as retrieving information of an unread message, displaying the unread message, etc.

In an embodiment of the present disclosure, the server may store a first time stamp corresponding to each dialogue of an instant messaging account. A communication window of a current instant messaging account with another instant messaging account (such as an account of a contact, a buddy list or a group list of the current instant messaging account) corresponds to a dialogue. Communication windows of the current instant messaging account with different instant messaging accounts separately correspond to different dialogues.

A new message is loaded into a window of the dialogue, the new message may be marked with a “read” indicator. A first time stamp of the dialogue corresponds to the time when a “read” indicator is stamped onto a new message that is most recently read in the dialogue. A message having time information that is larger than the first time stamp in the dialogue is determined as an unread message. When an instant messaging account is logged in at the current terminal, information of unread messages thereon is synchronized with the server. According to a synchronization mechanism based on the first time stamp, time information of a read message is synchronized with the server to ensure that time information of the most recently read message is stored in the server after the user read an unread message in the current terminal. When the user logs in via another terminal, the previously unread message has been labeled as a read message. Thus, when the other terminal processes unread messages, the problem of repeatedly sending the unread messages to different terminals and the problem of failing to synchronizing the statistics of information of unread messages are avoided, thus reducing the occupancy of server and terminal resources, achieving seamless synchronization of the information of the unread messages among different terminals and enhancing the experience of the user.

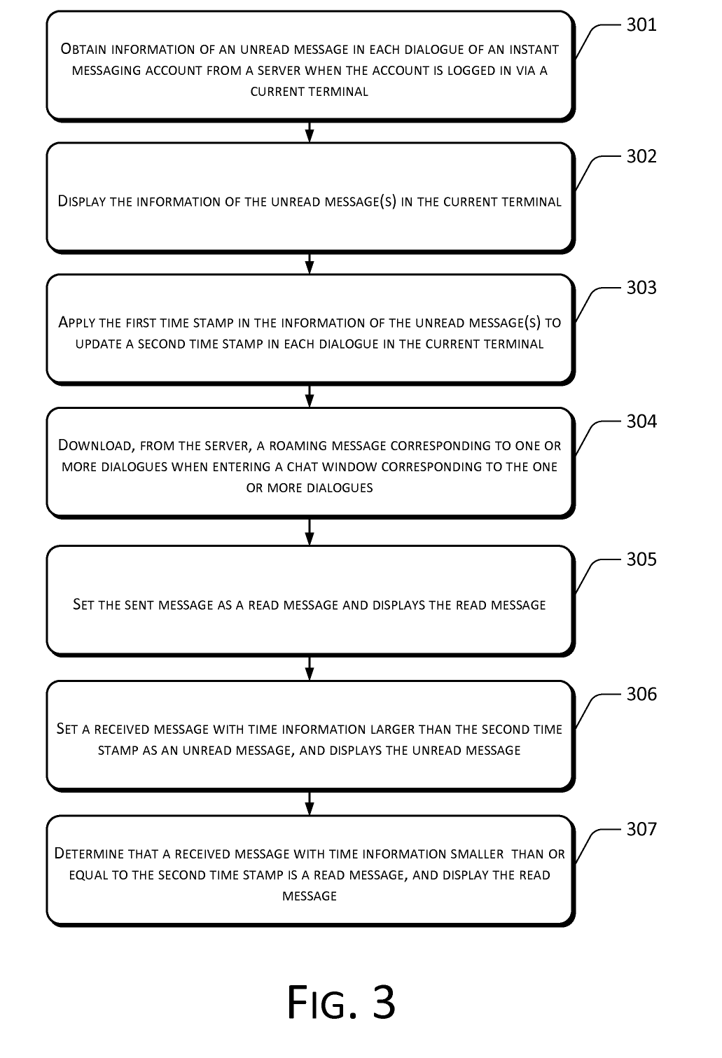

FIG. 3 illustrates a flow chart of a second example method of synchronizing an unread message of an instant communication, which may include the following.

Block 301 obtains information of an unread message in each dialogue of an instant messaging account from a server when the account is logged in via a current terminal.

It should be noted that an instant messaging account may be logged in at one or more terminals. When logging in via a current terminal, the same may be logged in via other terminals. The present disclosure does not have any limitations thereon. Specifically, the other terminals are terminals other than the current terminal that have the same instant messaging account logged in or had been logged in.

In a specific implementation, the current terminal may actively retrieve information of an unread message, or may passively receive the information of the unread message from a server.

Specifically, block 301 further comprises the following sub-blocks:

Sub-block S11 (not shown) sends a retrieving request for unread messages to a server when an instant messaging account is logged in via a current terminal, the server being used for retrieving information of unread message(s) in each dialogue corresponding to the instant messaging account.

Sub-block S12 (not shown) receives the information of the unread message(s) in each dialogue corresponding to the instant messaging account from the server.

The current terminal may send a request to retrieve information of unread message(s) in each dialogue of an instant messaging account based on an identifier, such as ID, of the account after the instant messaging account is logged in via a current terminal.

or,

Sub-block S13 (not shown) receives the information of the unread message(s) in each dialogue of the instant messaging account when the instant messaging account is logged in via the current terminal.

In response to detecting that the instant messaging account is logged in via the current terminal, the server may send information of the unread message(s) in each dialogue of the account to the current terminal.

As an embodiment of the present disclosure, the information of the unread message(s) comprises a first time stamp in each dialogue, a number of the unread message(s) in each dialogue, and/or the last message in each dialogue.

The first time stamp of each dialogue corresponds to time information of a message that is previously (i.e., most recently) read in each dialogue submitted for the instant messaging account.

The unread message in each dialogue corresponds to a message with time information being larger than the first time stamp in each dialogue.

The last message in each dialogue corresponds to a message that may be sent from or received by a currently logged-in instant messaging account, and may include content and/or time information of the last message.

The server sends information of most recent unread messages in one or more dialogues to the terminal, thus reducing the number of messages sent, reducing the system resource occupancy in the server, reducing the amount of data to be processed in the current terminal, and reducing the system resource occupancy in the current terminal.

Block 302 displays the information of the unread message(s) in the current terminal.

The unread message is a message with time information that is larger than the first time stamp in each dialogue. The first time stamp is time information of a most recently read message in each dialogue submitted by the account. The first time stamp corresponding to each dialogue of the account is stored in the server.

In a real application, the information of the unread message(s) may be displayed in a form of a text, an image, etc. The present disclosure does not have any limitations thereon.

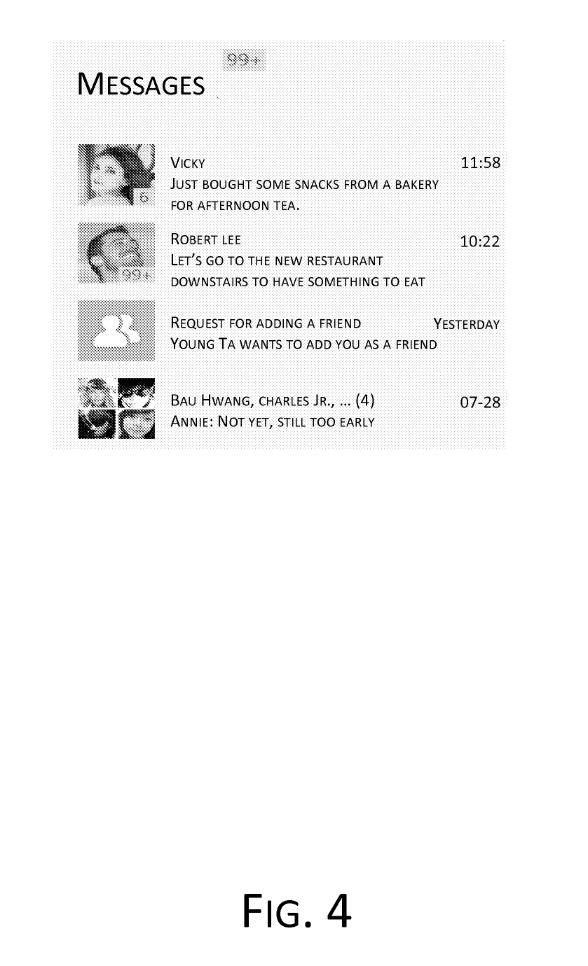

Using a mobile device of a Windows Phone system as an example. As shown in FIG. 4, for the number of unread messages, the present embodiment may display the number of unread messages in an icon of an instant messaging tool via an enhanced API (Application software Programming Interface) of the instant messaging tool in a form of numerical digits. For instance, there are 6 unread messages in a dialogue between the current instant messaging account and another account with a nickname “Vicky”. Furthermore, in order to improve user's experience, when the number of unread messages reaches or exceeds 100, an indicator of “99+” may be used. For example, there are more than 99 unread messages in a dialogue between the instant messaging IM account and another account with a nickname “Robert Lee”. In an embodiment, an indicator of “0” may be displayed in an icon or may not be displayed in a particular way if there is no unread message in a dialogue. For example, there is no unread message in a dialogue between the current instant messaging account and four other accounts with nicknames “Bau Hwang”, etc. The present embodiment may display the last message nearby a respective icon of the instant messaging tool to facilitate the user to identify a dialogue.

Block 303 applies the first time stamp in the information of the unread message(s) to update a second time stamp in each dialogue in the current terminal.

In a real application, a second time stamp corresponding to each dialogue may be stored in the current terminal. When receiving the second time stamp of each dialogue of the account from the server after logging in the account, the first time stamp is used for updating the corresponding second time stamp, so that the current terminal may keep time information of the most recently read message of each dialogue.

Block 304 downloads, from the server, a roaming message corresponding to one or more dialogues when entering a chat window corresponding to the one or more dialogues, the roaming messages including a message sent from or received by the account.

A roaming message corresponds to a historical message record of a terminal other than the current terminal, which is readable by the user when the same instant messaging account is logged in at a plurality of terminals or at different times.

Using this embodiment of the present disclosure, every time when a user logs in a certain instant message account by opening an instant messaging client in a terminal, the instant messaging client synchronizes a preset number of first historical message records with a server in response to detecting that the user opens a chat window of a certain buddy in that account at the first time. The preset number of the first historical message records corresponds to the latest historical message records stored in the server with respect to the chat window. It should be noted that the preset number is the number of historical message records that the chat window may display within a single page, which may be varied according to the size of the chat window and may be configured by the user or a developer. For example, if the number of historical message records within a single page of a chat window that serves a user with the best reading experience is 20, the preset number may be set as 20. The above approach of setting the preset number is only an example for the embodiment of the present disclosure. The present disclosure does not impose any limitation of a specific number for the preset number and the approach of setting the number.

In a specific implementation, after a certain instant messaging account is logged in at an instant messaging client, a determination is made as to whether a chat window associated with a certain buddy is opened for the first time, which may adopt the following method: establishing a data container to store buddy IDs of which respective chat windows have been opened for a certain instant messaging account; emptying the data container after that instant messaging account has been logged in successfully at an instant message client; retrieving a buddy ID corresponding to a chat window having a buddy relationship each time when the chat window is opened; searching for the buddy ID in the data container; if the ID is found, this indicates that the chat window of the buddy ID is not opened for the first time; otherwise, this indicates that the chat window of the buddy ID is opened for the first time, and the buddy ID is saved in the data container. As can be seen, since the data container is emptied each time when a same instant messaging account is logged in at a same terminal, a chat window related to each buddy has an opportunity of being opened for the first time when the instant messaging account is logged in again. When a chat window is opened for the first time, the most recent historical message record(s) of an associated buddy is/are retrieved from the server. For example, a user logged in a certain instant messaging account via a terminal and opened a chat window of a buddy A at 10 am. At that time, an instant messaging client synchronizes 20 up-to-date historical message records of the buddy A with the server. The user closed the chat window of the buddy A and signed off the instant messaging account thereafter. At 12 pm, the user logged in the same instant messaging account again via the same terminal, and opened the chat window of the buddy A. At this time, the instant messaging client determines that the chat window of the buddy A is opened for the first time, and synchronizes 20 most recent historical message records again with the server. The user closed the chat window of the buddy A, but did not log off from the instant messaging account. At 1 pm, the user opened the chat window of the buddy A again. At this time, the instant messaging client determines that the chat window was not opened for the first time, and so would not synchronize the most recent messages with the server.

Block 305 sets the sent message as a read message and displays the read message;

A read message corresponds to a message which has been read by the user. If a message in a dialogue is a message sent from the user, this message can be determined as a read message. Afterwards, a grey-scale operation may be performed on a text, or a prompt indicating that “the above are historical messages” may be correspondingly displayed.

and/or

Block 306 sets a received message with time information larger than the second time stamp as an unread message, and displays the unread message.

An unread message corresponds to a message which has not been read by the user, and a message having time information larger than the second time stamp (i.e., time information of the most recently read message in each dialogue that is submitted for the instant messaging account and received by the current terminal or another terminal) is set as an unread message. A text thereof may be highlighted, or a prompt indicating that “the above are unread messages” may be correspondingly displayed.

It should be noted that the time information may be converted into seconds for numerical comparison. For example, time information of a certain received message is 17:35, Nov. 20, 2013, and a second time stamp is 23:42, Nov. 19, 2013. In this case, the time information is larger than the second time stamp.

and/or

Block 307 determines that a received message with time information that is smaller than or equal to the second time stamp is a read message, and displays the read message.

A received message with time information smaller than or equal to the second time stamp (i.e., time information of the most recently read message in each dialogue that is submitted for the instant messaging account and received by the current terminal or another terminal) is a read message. A text may be converted to grey in color, or a prompt indicating that “the above are read messages” may be correspondingly displayed.

It should be noted that the time information may be converted into seconds for numerical comparison. For example, time information of a certain received message is 17:35, Nov. 18, 2013, and a second time stamp is 23:42, Nov. 19, 2013. In this case, the time information is smaller than the second time stamp.

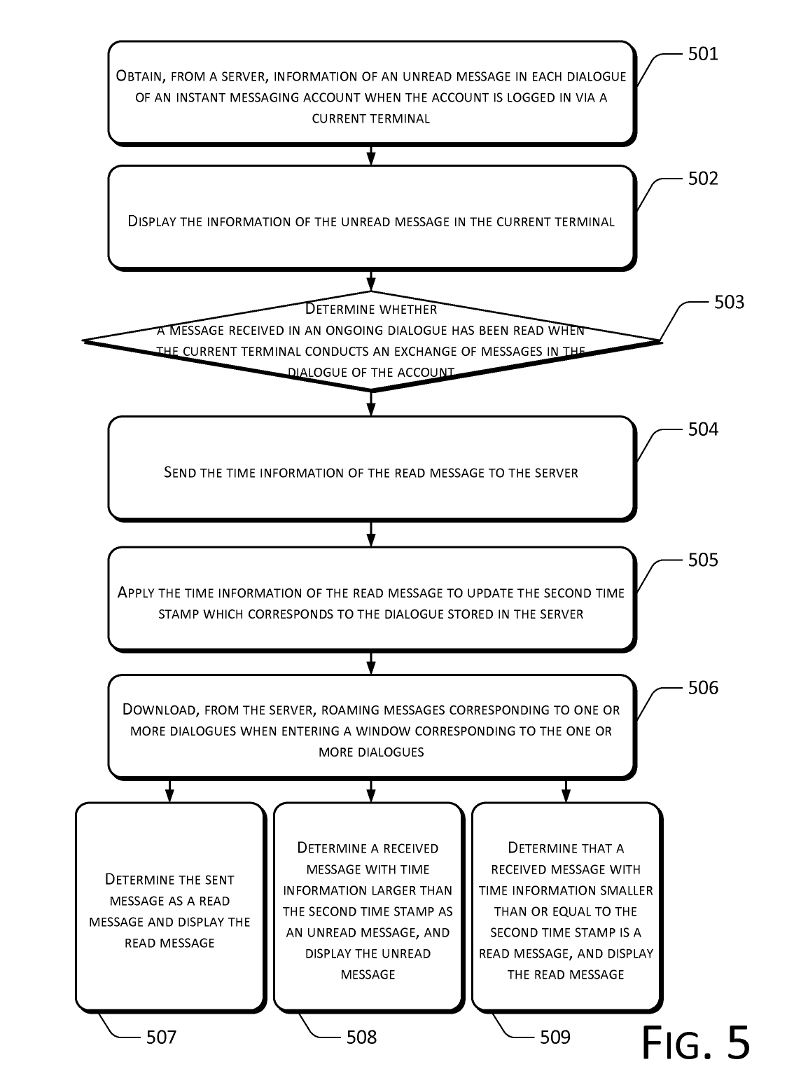

FIG. 5 illustrates a flow chart of a third example method of synchronizing an unread message of an instant messaging, which may include the following:

Block 501 obtains, from a server, information of an unread message in each dialogue of an instant messaging account when the account is logged in via a current terminal.

Block 502 displays the information of the unread message in the current terminal.

The unread message is a message with time information that is larger than a first time stamp in each dialogue. The first time stamp corresponds to time information of a most recently read message in each dialogue submitted by the account, and the first time stamp corresponding to each dialogue of the account is stored in the server.

Block 503 determines whether a message received in an ongoing dialogue has been read when the current terminal conducts an exchange of messages in the dialogue of the account, and block 504 is performed if affirmative.

Having been read means having been read by a user. Correspondingly, a message other than a read message is an unread message. In a real application, for messages received in each dialogue, time information of the most recently read message may be taken as a boundary line between a read message and an unread message. A message with time information that is larger than the time information of the most recently read message is an unread message, and a message with time information that is smaller than or equal to the time information of the most recently read message is a read message.

In an embodiment of the present disclosure, block 503 may include the following sub-blocks:

Sub-block S21 (not shown) determines whether a window of the ongoing dialogue is at focus, and if affirmative, sub-block S22 is performed.

Sub-block S22 (not shown) determines that a message currently received in the dialogue is a read message.

In this embodiment, in response to detecting that a window corresponding to a dialogue in an instant messaging tool (such as a chat window) is activated by a user and is set at focus, a message currently received in the dialogue is determined to be a read message. Specifically, the focused object may be a window corresponding to the dialogue and is located in the topmost layer in the current terminal and is not obscured by other windows.

and/or

Sub-block S23 (not shown) determines whether the window of the ongoing dialogue exceeds a default area of coverage, and if not, sub-block S24 is performed.

Sub-block 24 (not shown) determines that the message currently received in the dialogue is a read message.

In a terminal, i.e., a PC, running multiple windows, a user usually performs other operations (such as watching a movie) while reading a chat message in a dialogue (such as a group chatting). The window corresponding to the dialogue is not located in the front, but the message in the dialogue is still readable by the user. In this situation, an area of the window of the current dialogue obscured by other windows may be used for determining whether a message received in the dialogue has been read by a user.

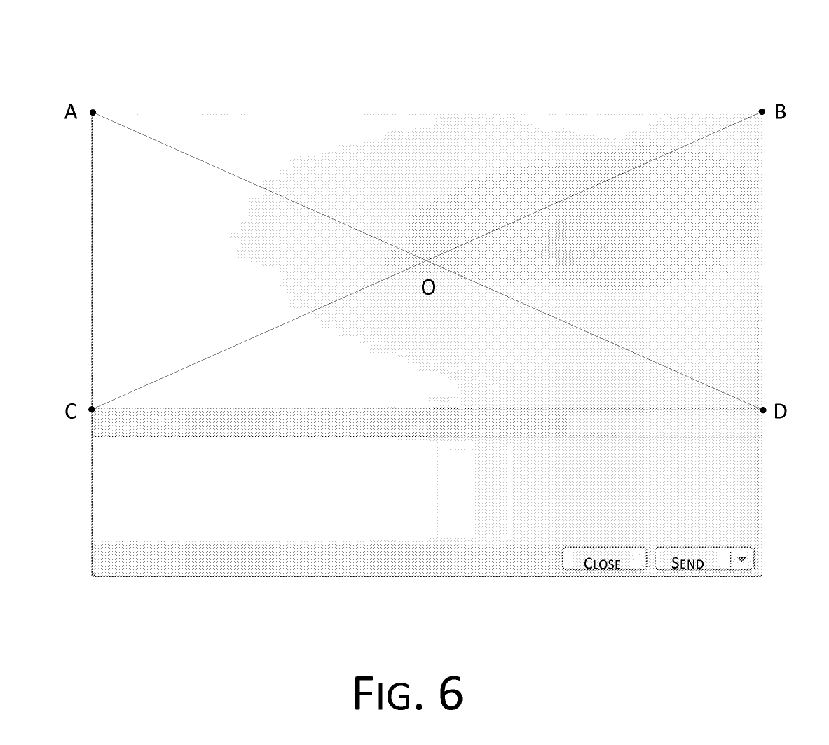

A half of the area of a window corresponding to a dialogue is used as an example of a predefined area. As shown in FIG. 6, the upper window is a message communication window of the dialogue, and the lower window is a message input window. Four points A, B, C and D are set at four corners of the message communication window in the dialogue, in which a point O is set at the center of the four points. In response to detecting that any three points from the points A, B, C, D and O are covered, the window corresponding to the dialogue is determined to be greater than the predefined area.

This embodiment ensures identification of the most recently read message by determining whether a message received in the ongoing dialogue has been read or not.

Block 504 sends the time information of the read message to the server, the server being used for updating the first time stamp corresponding to the dialogue using the time information, and determining that a message with time information that is larger than the first time stamp in the dialogue is an unread message.

It should be noted that, with respect to a current terminal, time information of a message in a dialogue may include transmitting sending time of another terminal and a receiving time of the current terminal. The time information of the message in the dialogue may use time information of a server as a basis. If a time delay between sending and receiving is not considered, the sending time and the receiving time of the message may be considered to be the same. If the time delay between sending and receiving is considered and as a specific relationship between the sending time and the receiving time of the message exists, either the sending time or the receiving time may be used universally as the time information in the embodiment of the present disclosure.

An identifier of the dialogue, such as a dialogue ID, may be contained in the time information of the read message sent from the current terminal. Upon receiving the time information of the most recently read message in the dialogue submitted by the current terminal, the server may use the time information to update the first time stamp corresponding to the dialogue, determine a message with time information larger than the first time stamp as an unread message, such that the statistics associated with information of unread messages in the dialogue may be performed.

In this embodiment, when determining whether the message received in the ongoing dialogue is a read message, the time information thereof is sent to the server to update the first time stamp. Using the embodiments of the present disclosure, other terminals also update the first time stamp in the same manner, such that the first time stamp of the server corresponds to the time information of the most recently read message received in the dialogue submitted for the account via the current terminal or the other terminals. The server determines whether a message is unread based on the first time stamp, thus ensuring the uniqueness and accuracy of an unread message, achieving a seamless synchronization of the unread message among different terminals, and improving the experience of a user.

Block 505 applies the time information of the read message to update the second time stamp which corresponds to the dialogue stored in the current terminal.

In another aspect, prior to block 504 or after block 506, the current terminal may update the second time stamp corresponding to the dialogue using the time information of the read message.

Block 506 downloads, from the server, roaming messages corresponding to one or more dialogues when entering a window corresponding to the one or more dialogues, the roaming messages including a message sent from the account and a message received by the account.

In this embodiment, when the user logs in a same instant messaging account via the current terminal and other terminals, the server may synchronize messages in respective dialogues in the current terminal and the other terminals. If time information of the most recently read message is the second time stamp updated at block 505, the second time stamp may be used for distinguishing between a read message and an unread message and a display thereof may be performed correspondingly. For example, a message that is not read by the user via the current terminal and the other terminals after the second time stamp is updated, or other users in the dialogue have not respond to a message sent by the user after the second time stamp is updated, etc.

Block 507 determines the sent message as a read message and displays the read message.

and/or

Block 508 determines a received message with time information that is larger than the second time stamp as an unread message, and displays the unread message.

and/or

Block 509 determines that a received message with time information smaller than or equal to the second time stamp is a read message, and displays the read message.

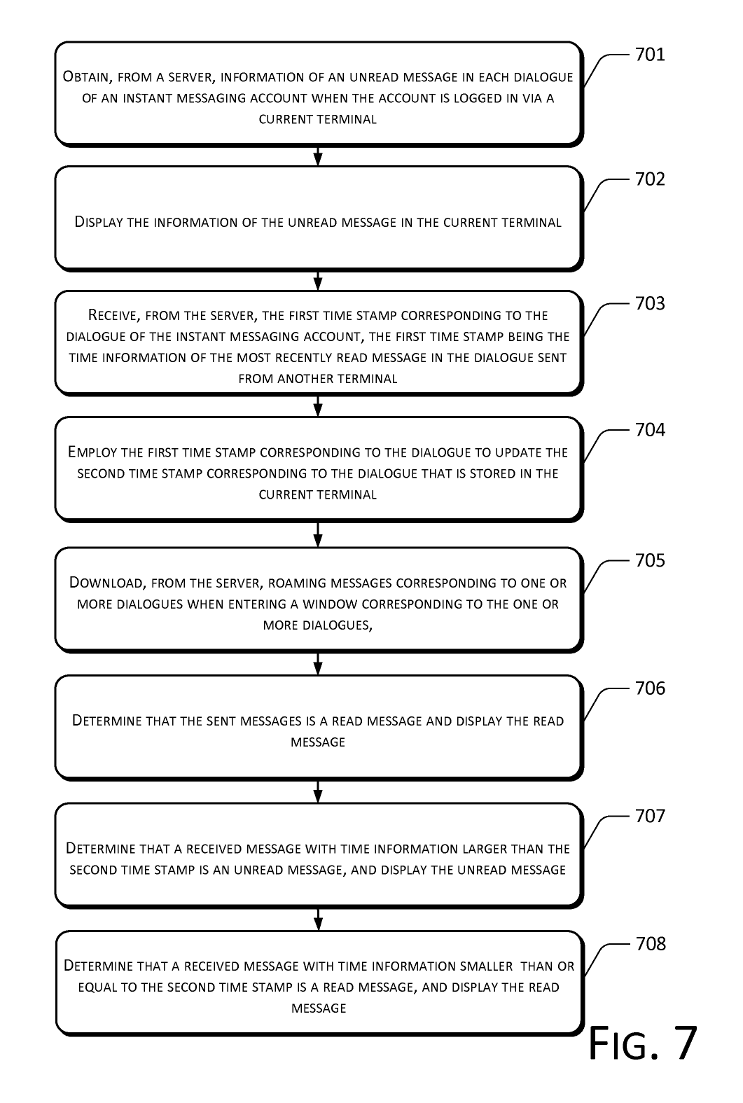

FIG. 7 is a flow chart of a fourth example method of synchronizing an unread message of instant communication, which may include the following:

Block 701 obtains, from a server, information of an unread message in each dialogue of an instant messaging account when the account is logged in via a current terminal.

Block 702 displays the information of the unread message in the current terminal.

The unread message in each dialogue is a message with time information that is larger than a first time stamp. The first time stamp corresponds to time information of the most recently read message in each dialogue submitted by the instant messaging account, and the first time stamp corresponding to each dialogue of the instant messaging account is stored in the server.

Block 703 receives, from the server, the first time stamp corresponding to the dialogue of the instant messaging account, the first time stamp being the time information of the most recently read message in the dialogue sent from another terminal.

In this embodiment, when a user logs in a same instant messaging account via a current terminal and other terminals at the same time, the server may synchronize messages in respective dialogues at the current terminal and the other terminals. If a certain terminal in the other terminals identifies time information of the most recently read message in a respective dialogue, the time information of the read message is sent to the server. The server applies the time information to update a second time stamp of the dialogue and sends the second time stamp to the rest of the terminals (which includes the current terminal) via which the same instant messaging account is currently logged in.

Block 704 employs the first time stamp corresponding to the dialogue to update the second time stamp corresponding to the dialogue that is stored in the current terminal.

After receiving the first time stamp, the current terminal may update the second time stamp corresponding to the dialogue using the first time stamp.

Block 705 downloads, from the server, roaming messages corresponding to one or more dialogues when entering a window corresponding to the one or more dialogues, the roaming messages comprising a message sent from the account and a message received by the account.

If time information of the most recently read message is the second time stamp updated at block 704, the second time stamp may be used for distinguishing between a read message and an unread message and a display thereof may be performed correspondingly. For example, a message that is not read by the user via the current terminal and the other terminals after the second time stamp is updated, or other users in the dialogue have not respond to a message sent by the user after the second time stamp is updated, etc.

Block 706 determines that the sent messages is a read message and displays the read message.

and/or

Block 707 determines that a received message with time information that is larger than the second time stamp is an unread message, and displays the unread message.

and/or

Block 708 determines that a received message with time information that is smaller than or equal to the second time stamp is a read message, and displays the read message.

In the embodiments of the present disclosure, when an instant messaging account is logged in via the current terminal for the first time, a first time stamp sent from the server is used for updating a second time stamp of each dialogue. Alternatively, upon determining that a message currently received in a dialogue is an unread message, a second time stamp corresponding to the dialogue is updated using time information of the unread message. Alternatively, when a same instant messaging account is logged in via a plurality of terminals, a first time stamp sent from the server is applied to update a corresponding second time stamp. Accordingly, the second time stamp of each dialogue may be maintained to be time information of the most recently read message received in each dialogue submitted by the instant messaging account on the current terminal or the other terminals. The current terminal determines whether a message is read or not read based on the second time stamp, and further displays information correspondingly, thus having strong practicability and flexibility, achieving seamless synchronization of unread messages among different terminals, and improving the experience of the user.

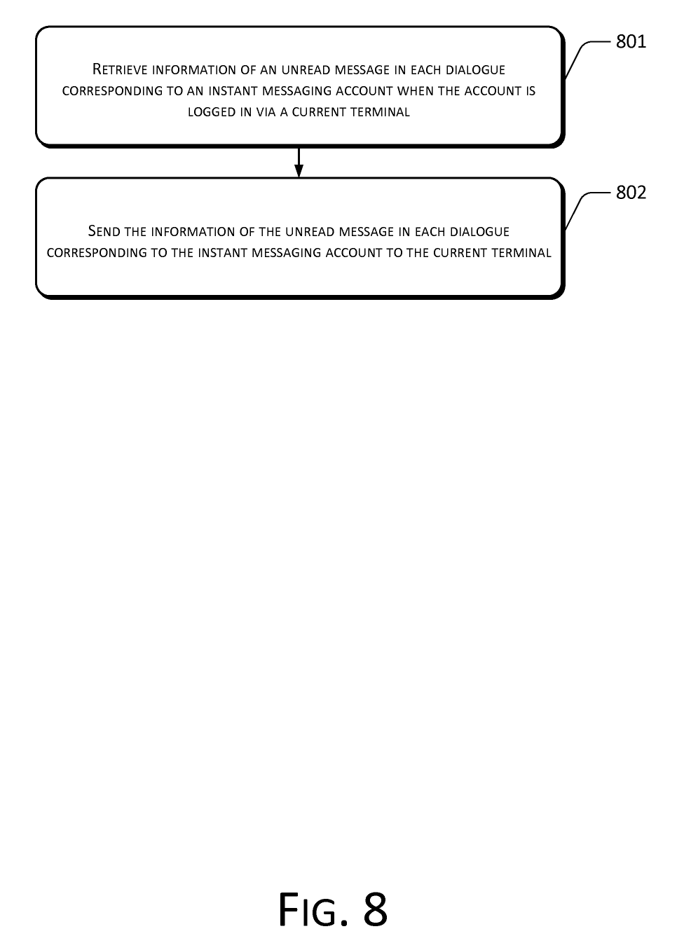

FIG. 8 is a flow chart of a fifth example method of synchronizing an unread message of instant communication, which may include the following:

Block 801 retrieves information of an unread message in each dialogue corresponding to an instant messaging account when the account is logged in via a current terminal.

Block 802 sends the information of the unread message in each dialogue corresponding to the instant messaging account to the current terminal.

The unread message is a message with time information that is larger than a first time stamp in each dialogue. The first time stamp corresponds to time information of a most recently read message in each dialogue submitted by the instant messaging account, and the first time stamp corresponding to each dialogue of the instant messaging account is stored in a server.

Since the fifth example method and the first example method correspond to each other, a description thereof is thus relatively simple. Reference may be made to related parts of the first example method, and thus this example method is not described in detail herein.

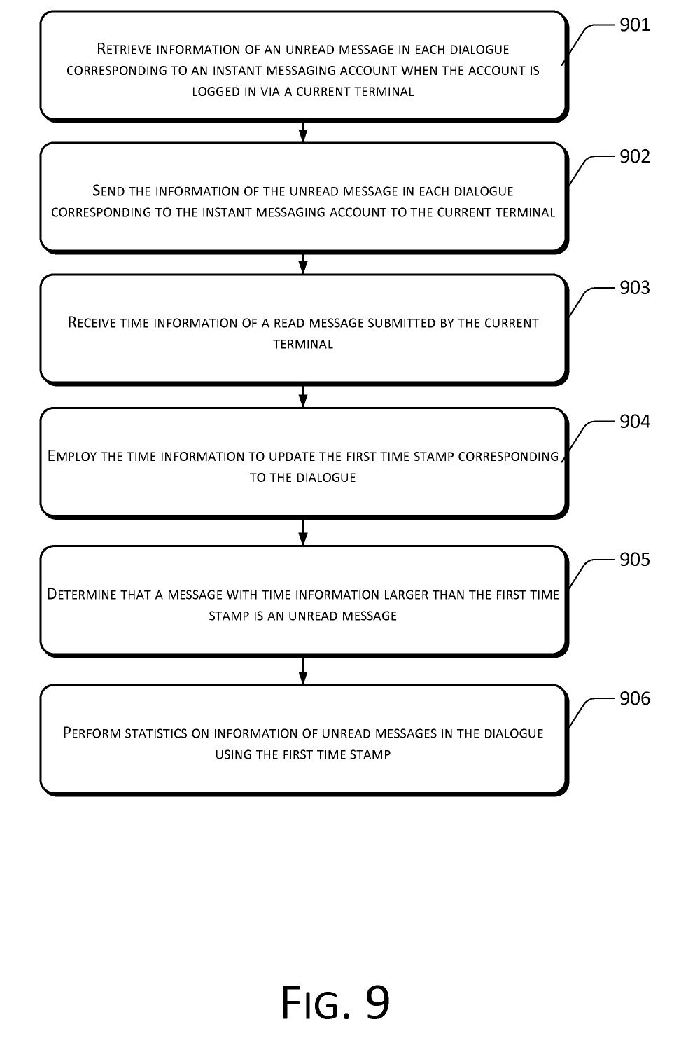

FIG. 9 is a flow chart of a sixth example method of synchronizing an unread message of instant communication, which may include the following:

Block 901 retrieves information of an unread message in each dialogue corresponding to an instant messaging account when the account is logged in via a current terminal.

It should be noted that an instant messaging account may be logged in via one or more terminals, i.e., may be logged in via other terminals when the instant messaging account is logged in via the current terminal. The present disclosure does not impose any limitation thereon. The other terminals correspond to terminals other than the current terminal, via which the same instant messaging account is logged in or has been logged in.

In a specific implementation, the current terminal may actively retrieve information of an unread message from the server, or may passively receive the information of the unread message from the server.

Block 901 further comprises sub-blocks as follows:

Sub-block S31 (not shown) retrieves information of an unread message in each dialogue corresponding to the instant messaging account when the account is logged in and a request for retrieving the information of the unread message is received in the current terminal.

and/or

Sub-block S32 (not shown) retrieves the information of the unread message in each dialogue corresponding to the instant messaging account when the account is logged in via the current terminal.

As an embodiment, the information of the unread message comprises: a first time stamp of each dialogue, a number of unread messages in each dialogue, and/or the last message in each dialogue.

Block 902 sends the information of the unread message in each dialogue corresponding to the instant messaging account to the current terminal.

The unread message in each dialogue is a message with time information that is larger than a first time stamp. The first time stamp corresponds to time information of a most recently read message in each dialogue submitted by the instant messaging account, and the first time stamp corresponding to each dialogue of the instant messaging account is stored in a server.

Block 903 receives time information of a read message submitted by the current terminal, the time information of the read message being time information of a message that is received in an ongoing dialogue and is determined by the current terminal as having been read when a message interaction is performed in the dialogue based on the account.

Block 904 employs the time information to update the first time stamp corresponding to the dialogue.

Block 905 determines that a message with time information that is larger than the first time stamp is an unread message.

Block 906 performs statistics on information of unread messages in the dialogue using the first time stamp.

In a specific implementation, the server may conduct statistics about information of unread messages after a dialogue is ended, which may include retrieving the first time stamp in each dialogue, counting the number of unread messages in each dialogue, and/or retrieving the most recent message in each dialogue.

Since the sixth example method and the second example method are corresponding to each other, a description thereof is thus relatively simple. Reference may be made to related parts of the second example method, and thus this example method is not described in detail herein.

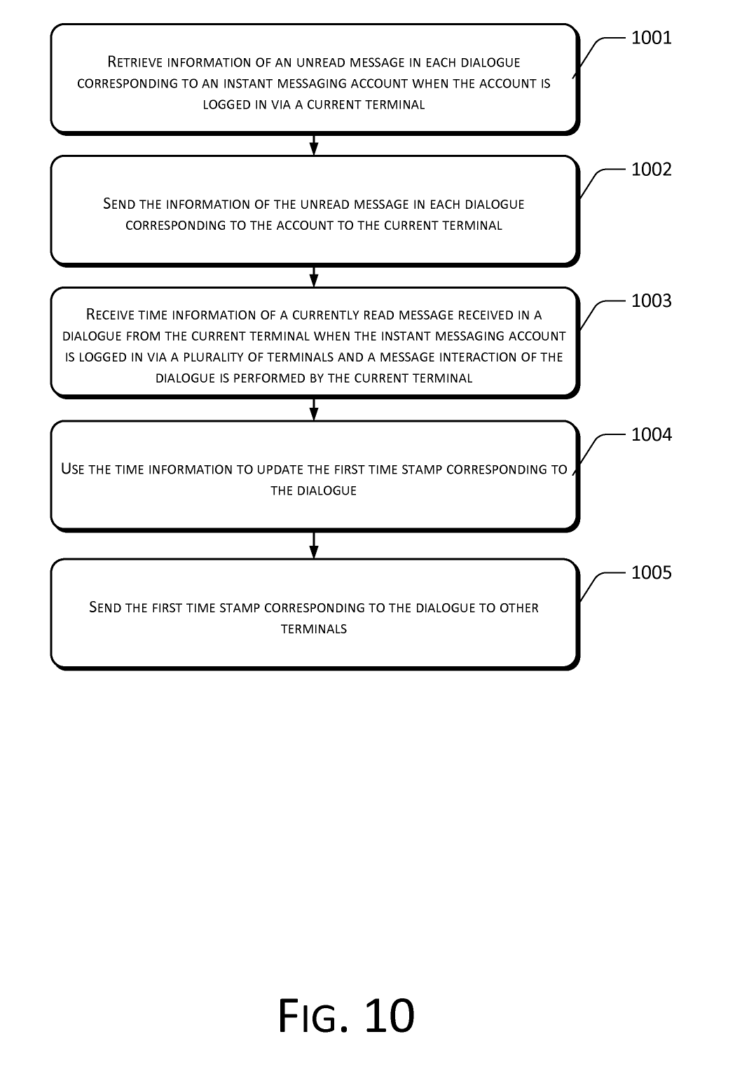

FIG. 10 illustrates a flow chart of a seventh example method of synchronizing an unread message of instant communication, which may include the following:

Block 1001 retrieves information of an unread message in each dialogue corresponding to an instant messaging account when the account is logged in via a current terminal.

Block 1002 sends the information of the unread message in each dialogue corresponding to the account to the current terminal.

The unread message is a message with time information that is larger than a first time stamp in each dialogue. The first time stamp corresponds to time information of a most recently read message in each dialogue submitted by the account, and the first time stamp corresponding to each dialogue of the account is stored in a server.

Block 1003 receives time information of a currently read message received in a dialogue from the current terminal when the instant messaging account is logged in via a plurality of terminals and a message interaction of the dialogue is performed by the current terminal.

Block 1004 uses the time information to update the first time stamp corresponding to the dialogue.

Block 1005 sends the first time stamp corresponding to the dialogue to other terminals.

Since the seventh example method and the fourth example method correspond to each other, a description thereof is thus relatively simple. Reference may be made to related parts of the fourth example method, and thus this example method is not described in detail herein.

It should be noted that, the method embodiments of the present disclosure are described as a sequence of actions for ease of description. However, one skilled in the art should understand that the present disclosure is not limited to the described order of actions because some method blocks may be performed simultaneously or in another order based on the embodiments of the present disclosure. Furthermore, one skilled in the art should also understand that the embodiments described in this disclosure are exemplary embodiments, and actions and modules involved therein may not be essential to the embodiments of the present disclosure.

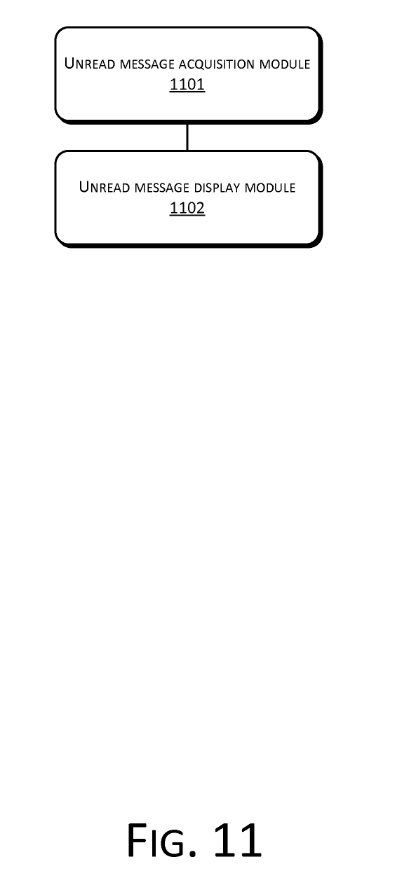

FIG. 11 illustrates a structural diagram of a first example system of synchronizing an unread message of instant communication, which may include the following modules:

an unread message acquisition module 1101 used for obtaining information of an unread message in each dialogue associated with an instant messaging account from a server when the account is logged in via a current terminal; and

an unread message display module 1102 used for displaying the information of the unread message in the current terminal,

wherein the unread message is a message with time information that is larger than a first time stamp in each dialogue, the first time stamp being time information of a most recently read message in each dialogue submitted by the instant messaging account, and the first time stamp corresponding to each dialogue of the instant messaging account being stored in the server.

In an embodiment of the present disclosure, the information of the unread message comprises: the first time stamp in each dialogue, a number of unread messages in each dialogue, and/or the last message in each dialogue.

In an embodiment of the present disclosure, other terminals correspond to terminals other than the current terminal, via which the same instant messaging account is logged in or has been logged in.

In an embodiment of the present disclosure, the system may further include the following module:

a first updating module (not shown) used for applying the first time stamp in the information of the unread message to update a second time stamp in each dialogue on the current terminal.

In an embodiment of the present disclosure, the system may further include the following modules:

a read determination module (not shown) used for determining whether a message received in an ongoing dialogue has been read when an exchange of messages is performed in the dialogue on the current terminal based on the instant messaging account, and if affirmative, calling a time information sending module (not shown);

the time information sending module used for sending the time information of the read message to the server, the server being used for updating the first time stamp corresponding to the dialogue using the time information, determining that a message in the dialogue having respective time information larger than the first time stamp is an unread message.

In an embodiment of the present disclosure, the read determination module may further include the following modules:

a focus determination sub-module (not shown) used for determining whether a window corresponding to the ongoing dialogue is at focus, and if affirmative, invoking a read determination sub-module;

and/or

a coverage determination sub-module (not shown) used for determining whether the window corresponding to the ongoing dialogue exceeds a default area of coverage, and if not, invoking the read determination sub-module (not shown); and

the read determination sub-module used for determining that the message currently received in the dialogue has been read.

In an embodiment of the present disclosure, the system may further include the following module:

a second updating module (not shown) used for updating the second time stamp corresponding to the dialogue that is stored in the server using time information of the read message.

In an embodiment of the present disclosure, the system may further include the following module:

a first time stamp receiving module (not shown) used for receiving the first time stamp corresponding to the dialogue of the instant messaging account from the server, the first time stamp being time information of a most recent read message in the dialogue sent from another terminal.

In an embodiment of the present disclosure, the system may further include the following module:

a third updating module (not shown) used for applying the first time stamp corresponding to the dialogue to update the second time stamp in the dialogue stored in the current terminal.

In an embodiment of the present disclosure, the system may further include the following modules:

a roaming message downloading module (not shown) used for downloading roaming messages corresponding to one or more dialogues from the server when entering a window corresponding to the one or more dialogues, the roaming messages including a message sent from instant messaging account and a message received by the instant messaging account;

a first read message processing sub-module (not shown) used for setting the sent message as a read message and displaying the read message;

and/or

an unread message processing sub-module (not shown) used for setting a received message with respective time information larger than the second time stamp as an unread message, and displaying the unread message;

and/or

a second read message processing sub-module (not shown) used for setting a received message with respective time information smaller than or equal to the second time stamp as a read message, and displaying the read message.

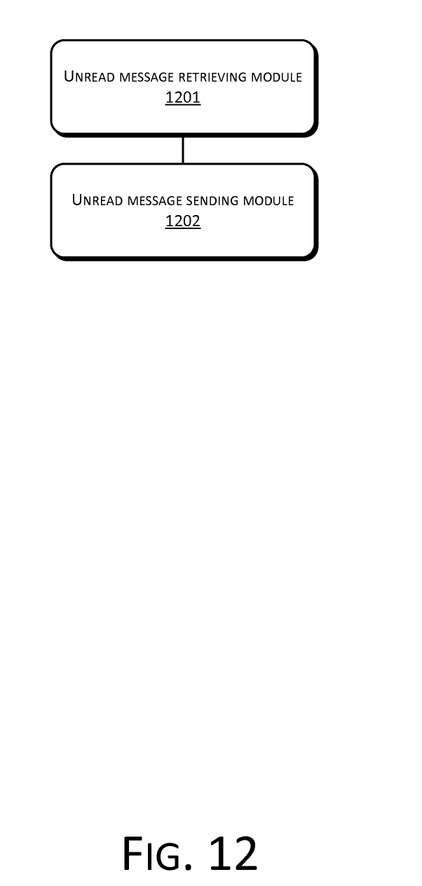

FIG. 12 illustrates a structural diagram of a system for synchronizing an unread message of an instant communication, which may include the following modules:

an unread message retrieving module 1201 used for retrieving information of an unread message in each dialogue corresponding to an instant messaging account when the instant messaging account is logged in at a current terminal;

an unread message sending module 1202 used for transmitting the information of the unread message in each dialogue corresponds to the instant messaging account to the current terminal, wherein the unread message in each dialogue is a message with time information being larger than a first time stamp, the first time stamp is time information of a most recent read message in each dialogue submitted by the instant messaging account, and the first time stamp corresponding to each dialogue of the instant messaging account is stored in a server.

In an embodiment of the present disclosure, the information of the unread message comprises: the first time stamp in each dialogue, a number of unread messages in each dialogue, and/or the last message in each dialogue.

In an embodiment of the present disclosure, other terminals correspond to terminals, other than the current terminal, via which the same instant messaging account is logged in or has been logged in.

In an embodiment of the present disclosure, the system may further include the following modules:

a first time information receiving module (not shown) used for receiving the time information of the read message submitted from the current terminal, wherein the time information of the read message is time information of a message that is received by an ongoing dialogue and is determined by the current terminal to have been read when an exchange of messages is conducted in the ongoing dialogue based on the instant messaging account;

a fourth updating module (not shown) used for updating the first time stamp corresponding to the dialogue using the time information; and

an unread message determination module (not shown) used for setting a message with time information larger than the first time stamp as an unread message.

In an embodiment of the present disclosure, the system may further include the following module:

an unread message statistics module (not shown) used for applying the first time stamp to perform statistics on information of unread messages in the dialogue.

In an embodiment of the present disclosure, the system may further include the following modules:

a second time information receiving module (not shown) used for receiving time information of read messages currently received in the dialogue from the current terminal when the instant messaging account is logged in at a plurality of terminals and an exchange of messages is conducted in the dialogue by the current terminal;

a fifth updating module (not shown) used for applying the time information to update the first time stamp corresponding to the dialogue;

a first time stamp sending module (not shown) used for transmitting the first time stamp corresponding to the dialogue to other terminals.

Since the system embodiments are basically similar to the method embodiments of the present disclosure, a description thereof is relatively simple. Related parts in the method embodiments may be cross-referenced.

Each embodiment of the present disclosure is described in a progressive manner. The emphasis in each embodiment is different from those in other embodiments. Same or similar portions of various embodiments may be referenced with one another.

One skilled in the art should understand that the embodiments of the present disclosure can be provided as a method, a system or a product of a computer program. Therefore, the present disclosure can be implemented as an embodiment of only hardware, an embodiment of only software or an embodiment of a combination of hardware and software. Moreover, the present disclosure can be implemented as a product of a computer program that can be stored in one or more computer readable storage media (which includes but is not limited to, a magnetic disk, a CD-ROM or an optical disk, etc.) that store computer-executable instructions.

In a typical configuration, a computing device includes one or more processors (CPU), input/output interfaces, a network interface and memory.

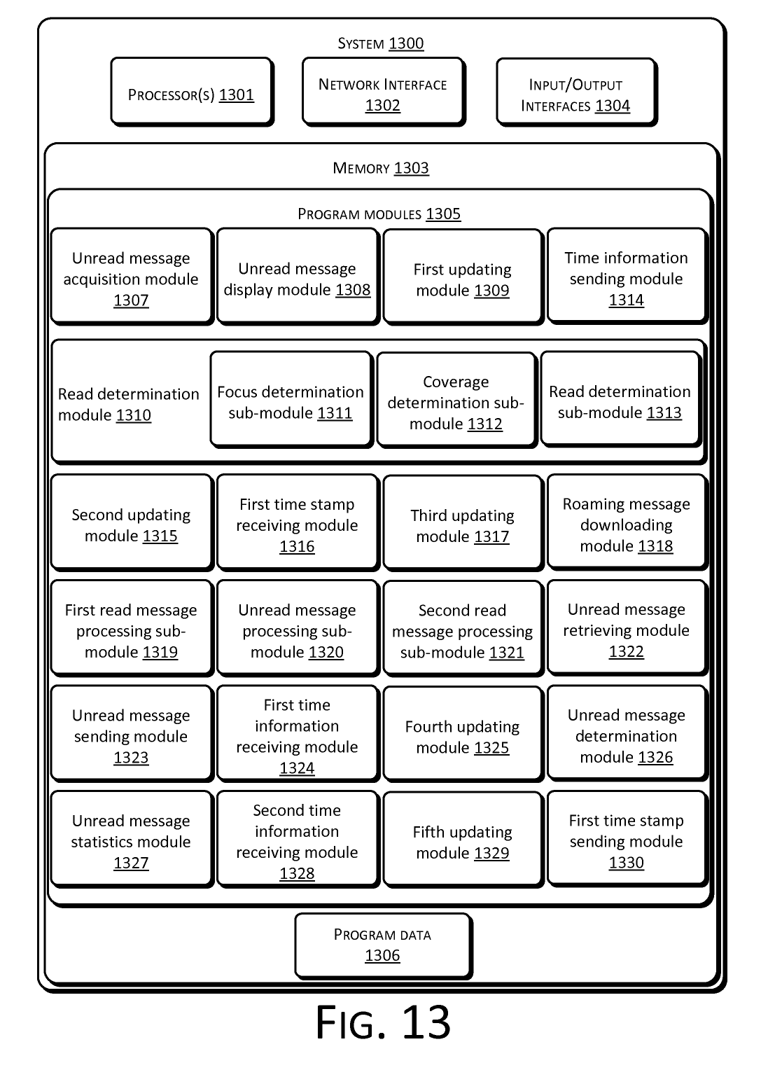

For example, FIG. 13 shows an example system 1300, such as the system as described above, in more detail. In an embodiment, the system 1300 may include, but is not limited to, one or more processors 1301, a network interface 1302, memory 1303 and/or an input/output interface 1304.

The memory 1303 may be a form of computer readable media, e.g., a non-permanent storage device, random-access memory (RAM) and/or a nonvolatile internal storage, such as read-only memory (ROM) or flash RAM. The memory 1303 is an example of computer readable media. The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 1303 may include program modules 1305 and program data 1306. In an embodiment, the program modules 1305 may include an unread message acquisition module 1307, an unread message display module 1308, a first updating module 1309, a read determination module 1310 (which may include a focus determination sub-module 1311, a coverage determination sub-module 1312, a read determination sub-module 1313), a time information sending module 1314, a second updating module 1315, a first time stamp receiving module 1316, a third updating module 1317, a roaming message downloading module 1318, a first read message processing sub-module 1319, an unread message processing sub-module 1320, a second read message processing sub-module 1321, an unread message retrieving module 1322, an unread message sending module 1323, a first time information receiving module 1324, a fourth updating module 1325, an unread message determination module 1326, an unread message statistics module 1327, a second time information receiving module 1328, a fifth updating module 1329 and/or a first time stamp sending module 1330. Details of these modules and sub-modules may be found in the foregoing description and are therefore not redundantly described herein.

The present disclosure is described in accordance with flowcharts and/or block diagrams of the exemplary methods, mobile apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing mobile device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing mobile device.

Such computer program instructions may also be stored in a computer readable memory device which may cause a computer or another programmable data processing mobile apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may a series of operations may be executed by the computer or the other data processing mobile apparatus to generate computer implemented processing. Therefore, the instructions executed by the computer or the other programmable apparatus may be used to implement one or more processes of the flowcharts and/or one or more blocks of the block diagrams.

Although the exemplary embodiments of the present disclosure have been described herein, one skilled in the art can make changes and modifications to these embodiments after understanding the fundamental creative concept of the present disclosure. The claims attached herein intend to include the preferred embodiments and all changes and modifications covered by the embodiments of the present disclosure.

Finally, it should be noted that terms such as “first” and “second” are only used for differentiating an entity or operation from another entity or operation, but do not necessarily request or imply any existence of this type of real relationship or ordering between the entities or operations. Moreover, terms such as “comprise”, “include” or any other variations thereof are meant to cover the non-exclusive inclusions. The process, method, product or mobile apparatus that includes a series of elements not only includes those elements, but also includes other elements that are not explicitly listed, or further includes elements that already existed in such process, method, product or mobile apparatus. In a condition without further limitations, an element defined by the phrase “include a/an . . . ” does not exclude any other similar elements from existing in the process, method, product or apparatus.

Detailed descriptions of the methods and systems of synchronizing unread messages in instant communication in accordance with the present disclosure have been described above. The specification explains the principles and implementations of the present disclosure using specific embodiments. The foregoing embodiments are merely used for helping to understand the methods and core concepts of the present disclosure. Also, based on the concepts of the present disclosure, one of ordinary skill in the art may change specific implementations and scope of applications. In short, the present specification shall be not construed as limitations to the present disclosure.

What is claimed is:

1. A method implemented by one or more computing devices, the method comprising:
obtaining information of an unread message in a dialogue associated with an instant messaging account from a server when the account is logged in via a current terminal; and
displaying the information of the unread message in the current terminal, wherein the unread message is a first message with time information that is later than a first time stamp in the dialogue, the first time stamp being time information of a most recently read message in the dialogue submitted by the instant messaging account, and the first time stamp corresponding to the dialogue of the instant messaging account being stored in the server.

2. The method according to claim 1, wherein the information of the unread message comprises the first time stamp in the dialogue, a number of unread messages in the dialogue, a last message in the dialogue or any combination thereof.

3. The method according to claim 1, wherein other terminals correspond to terminals, other than the current terminal, via which the same instant messaging account is logged in or has been logged in.

4. The method according to claim 1, further comprising applying the first time stamp in the information of the unread message to update a second time stamp in the dialogue on the current terminal.

5. The method according to claim 1, further comprising:
determining whether a message received in the dialogue has been read when an exchange of messages is performed in the dialogue on the current terminal based on the instant messaging account; and
sending the time information of the read message to the server in response to determining that the message received in the ongoing dialogue has been read, the server being used for updating the first time stamp corresponding to the dialogue using the time information.

6. The method according to claim 5, wherein determining whether the message received in the ongoing dialogue has been read, further comprises:
determining whether a window corresponding to the ongoing dialogue is at focus, and if affirmative, determining that the message received in the ongoing dialogue is a read message; and/or
determining whether the window corresponding to the ongoing dialogue exceeds a default area of coverage, and if not affirmative, determining that the message received in the ongoing dialogue is a read message.

7. The method according to claim 5, further comprising updating the first time stamp corresponding to the dialogue that is stored in the server using time information of the read message.

8. The method according to claim 5, further comprising updating a second time stamp corresponding to the dialogue that is stored in the current terminal using time information of the read message.

9. The method according to claim 1, further comprising receiving the first time stamp corresponding to the dialogue of the instant messaging account from the server, the first time stamp being time information of a most recent read message in the dialogue sent from another terminal.

10. A method according to claim 9, further comprising applying the first time stamp corresponding to the dialogue to update a second time stamp in the dialogue stored in the current terminal.

11. A method according to claim 10, further comprising:
downloading roaming messages corresponding to one or more dialogues from the server when entering a window corresponding to the one or more dialogues, the roaming messages including a message sent from instant messaging account and a message received by the instant messaging account;
setting the sent message as a read message and displaying the read message;
setting a received message with respective time information larger than the second time stamp as an unread message, and displaying the unread message; and/or
setting a received message with respective time information smaller than or equal to the second time stamp as a read message, and displaying the read message.

12. The method according to claim 1, wherein the unread message corresponds to a message in the dialogue with time information is larger than the first time stamp.

13. One or more computer readable media storing executable instructions that, when executed by one or more processors, cause the one or more processors to perform acts comprising:
retrieving information of an unread message in a dialogue corresponding to an instant messaging account when the instant messaging account is logged in at a current terminal;
transmitting the information of the unread message in the dialogue corresponds to the instant messaging account to the current terminal, wherein the unread message in the dialogue is a message with time information that is larger than a first time stamp, the first time stamp is time information of a most recent read message in the dialogue submitted by the instant messaging account, and the first time stamp corresponding to the dialogue of the instant messaging account is stored in a server.

14. One or more computer readable media according to claim 13, the acts further comprising:
receiving the time information of the read message submitted from the current terminal, wherein the time information of the read message is time information of a message that is received by the dialogue and is determined by the current terminal to have been read when an exchange of messages is conducted in the ongoing dialogue based on the instant messaging account;
updating the first time stamp corresponding to the dialogue using the time information; and
setting a message with time information larger than the first time stamp as an unread message.

15. One or more computer readable media according to claim 14, the acts further comprising applying the first time stamp to perform statistics on information of unread messages in the dialogue.

16. One or more computer readable media according to claim 13, the acts further comprising:
receiving time information of read messages currently received in the dialogue from the current terminal when the instant messaging account is logged in at a plurality of terminals and an exchange of messages is conducted in the dialogue by the current terminal;
applying the time information to update the first time stamp corresponding to the dialogue; and
transmitting the first time stamp corresponding to the dialogue to other terminals.

17. One or more computer readable media according to claim 13, wherein the information of the unread message comprises: the first time stamp in the dialogue, a number of unread messages in the dialogue, and/or a last message in the dialogue.

18. A system of synchronizing an unread message of instant communication, comprising:
one or more processors;
memory;
an unread message acquisition module stored in the memory and executable by the one or more processors to obtain information of an unread message in each dialogue associated with an instant messaging account from a server when the account is logged in via a current terminal; and
an unread message display module stored in the memory and executable by the one or more processors to display the information of the unread message in the current terminal, wherein the unread message is a message with time information that is larger than a first time stamp in each dialogue, the first time stamp being time information of a most recently read message in each dialogue submitted by the instant messaging account, and the first time stamp corresponding to each dialogue of the instant messaging account being stored in the server.

19. A system according to claim 18, further comprising a first updating module used for applying the first time stamp in the information of the unread message to update a second time stamp in each dialogue on the current terminal.

20. A system according to claim 18, further comprising:
a read determination module used for determining whether a message received in an ongoing dialogue has been read when an exchange of messages is performed in the dialogue on the current terminal based on the instant messaging account, and if affirmative, calling a time information sending module;
the time information sending module used for sending the time information of the read message to the server, the server being used for updating the first time stamp corresponding to the dialogue using the time information, determining that a message in the dialogue having respective time information larger than the first time stamp is an unread message.

21. A system according to claim 20, further comprising:
a focus determination sub-module used for determining whether a window corresponding to the ongoing dialogue is at focus, and if affirmative, invoking a read determination sub-module; and/or
a coverage determination sub-module used for determining whether the window corresponding to the ongoing dialogue exceeds a default area of coverage, and if not, invoking the read determination sub-module; and
the read determination sub-module used for determining that the message currently received in the dialogue has been read.

22. A system according to claim 20, further comprising a second updating module used for updating a second time stamp corresponding to the dialogue that is stored in the current terminal using time information of the read message.

23. A system according to claim 20, further comprising a second updating module used for updating the first time stamp corresponding to the dialogue that is stored in the server using time information of the read message.
